(19) United States
(12) Patent Application Publication
(10) Pub. No.: US 2008/0241606 A1
(43) Pub. Date: Oct. 2, 2008

(54) METHOD AND APPARATUS FOR HUMIDIFYING A GAS IN FUEL CELL SYSTEMS

(76) Inventor: Emerson R. Gallagher, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/694,562

(22) Filed: Mar. 30, 2007

(51) Int. Cl. H01M 8/00; H01M 8/12

(52) U.S. Cl. 429/13; 429/12; 429/22

(57) ABSTRACT

A membrane exchange humidifier for use with a fuel cell system, fuel cell or fuel cell stack includes at least one wet chamber, a plurality of dry chambers, a water permeable sheet membrane; wherein each of the plurality of dry chambers is separated from one or more of the at least one wet chambers by the water permeable sheet membrane, whereby water is capable of being transferred across the water permeable sheet membrane; and a variable flow cross section restriction device fluidly connects to at least one of the plurality of dry chambers.

### BACKGROUND OF THE INVENTION

1. Field of the Invention

The present disclosure generally relates to fuel cell systems and more particularly relates a method and apparatus for humidifying a gas in a fuel cell.

2. Description of the Related Art

In membrane exchange humidifiers, a fluid stream to be humidified (the dry stream) is directed over one side of a water permeable membrane while the fluid stream supplying the water (the wet stream) is directed over the opposing side of the membrane. Water from the wet stream passes through the membrane thereby humidifying the dry stream. Membrane exchange humidifiers have been used for many purposes including fuel cell systems.

Fuel cells convert fuel and oxidant to electricity and reaction product. Proton exchange membrane fuel cells generally employ a membrane electrode assembly (“MEA”) consisting of an ion exchange membrane disposed between two electrodes formed of porous, electrically conductive sheet material, typically carbon fiber paper. The ion exchange membrane facilitates the migration of hydrogen ions from the anode to the cathode. In addition to conducting hydrogen ions, the membrane isolates the hydrogen-containing fuel stream from the oxygen-containing oxidant stream. At the cathode, oxygen reacts at the catalyst layer to form anions. The anions formed at the cathode react with the hydrogen ions that have crossed the membrane to form liquid water as the reaction product. The anode and cathode reactions in hydrogen/oxygen fuel cells are shown in the following equations:

H₂→2H₊+2e⁻ (1)

½O₂+2H₊+2e⁻→H₂O (2)

Product liquid water or water vapor is typically exhausted via the oxidant stream exhaust as excess water that accumulates in the fuel cell may be problematic. In particular, the presence of liquid water reduces the accessibility of the catalyst to the reactants, interferes with the permeation of reactants through the cathode to the catalyst, and may impart physical changes to the adjacent membrane, causing localized swelling and expansion. To remove water from the fuel cell, the oxidant supply stream may be pressurized by a compressor, fan, pump, jet pump, recirculation pump or other like means known in the art, upstream of the oxidant inlet, setting up a pressure drop across the fuel cell system.

However, it is not desirable to remove all water from the fuel cell system. In a proton exchange membrane fuel cell, the ionic conductivity of the ion exchange membrane and the performance of the fuel cell are affected by the hydration level (both generally increasing with water content). Therefore, fuel cell systems typically employ a membrane exchange humidifier to humidify the fuel and/or oxidant reactant gas streams in order to maintain an adequate level of hydration in the ion exchange membrane. The fuel cell oxidant exhaust typically contains sufficient water for the purposes of humidifying a reactant stream and therefore, typically fills the role of the wet stream.

In many applications, fuel cell systems operate with a high turn-down ratio. Therefore, it is important to have a membrane exchange humidifier that is effective at both high flows and low flows. The efficacy of the membrane exchange humidifier is, in part, influenced by its flow restriction, defined principally by the physical shape, size and geometric make-up of the membrane exchange humidifier. Flow restriction is an important parameter for two reasons. First, flow restriction influences the effectiveness of the humidity exchange. Second, the flow restriction influences the pressure drop across the membrane exchange humidifier. The lower the pressure drop of the membrane exchange humidifier, the less any compression device must work to maintain sufficient pressure drop across the fuel cell system for water clearing purposes.

A high flow restriction membrane exchange humidifier, for example, has a more effective humidity exchange at low flows and is therefore desirable at such low flows. However, a high flow restriction membrane exchange humidifier also has a high pressure drop, and will therefore require more oxidant compression to maintain sufficient pressure drop across the fuel cell for water clearing purposes, resulting in a greater parasitic load on the fuel cell system.

A low flow restriction membrane exchange humidifier, on the other hand, has poor humidity exchange at low flow. However, a low flow membrane exchange humidifier has sufficient humidify exchange at high flows and has a low associated pressure drop, allowing the compressor to have a lower parasitic load on the system.

An ideal humidifier design will have adequate humidification of a reactant stream at all flow levels and will also have a minimal pressure drop at all flow levels. However, membrane exchange humidifiers known in the art (e.g., plate and frame, pleated and other varieties) have a fixed flow restriction optimized for less than its whole operating range.

Therefore, there remains a need in the art for a membrane exchange humidifier or a system of membrane exchange humidifiers that overcomes these and associated problems. The embodiments disclosed herein address these needs and provide associated benefits.

### BRIEF SUMMARY OF THE INVENTION

In one embodiment, a fuel cell membrane exchange humidifier is disclosed including at least one wet chamber; a plurality of dry chambers; a water permeable sheet membrane. Each of the plurality of dry chambers is separated from one or more of the at least one wet chambers by the water permeable sheet membrane, whereby water is capable of being transferred across the water permeable sheet membrane. The fuel cell membrane exchange humidifier also includes a variable flow cross section restriction device that is fluidly connected to at least one of the plurality of dry chambers.

In another embodiment, a fuel cell system includes a fuel cell comprising a fuel cell reactant inlet and a fuel cell oxidant exhaust; and a membrane exchange humidifier. The membrane exchange humidifier includes a dry stream inlet; a plurality of dry chambers; at least one wet chamber; and a water permeable sheet membrane, wherein each of the plurality of dry chambers is separated from one or more of the at least one wet chambers by the water permeable sheet membrane whereby water is capable of being transferred across the water permeable sheet membrane. The dry chambers are fluidly coupled between the dry stream inlet and the fuel cell reactant inlet and the fuel cell oxidant exhaust is fluidly coupled to the at least one wet chambers. A variable flow cross section restriction device is fluidly connected to at least one of the plurality of dry chambers.

In another embodiment, a fuel cell membrane exchange humidifier includes at least one wet chamber; a plurality of dry chambers defining a net flow cross section; a water permeable sheet membrane; wherein each of the plurality of dry chambers is separated from one or more of the at least one wet chambers by the water permeable sheet membrane; and a restriction means to variably restrict the net flow cross section of the plurality of dry chambers.

In another embodiment, a fuel cell system includes a fuel cell comprising a fuel cell reactant inlet; and a fuel cell oxidant exhaust; and a membrane exchange humidifier. The membrane exchange humidifier includes a dry stream inlet; a plurality of dry chambers defining a net flow cross section; at least one wet chamber; and a water permeable sheet membrane, wherein each of the plurality of dry chambers is separated from one or more of the at least one wet chambers by the water permeable sheet membrane whereby water is capable of being transferred across the water permeable sheet membrane. The dry chambers are fluidly coupled between the dry stream inlet and the fuel cell reactant inlet. The fuel cell oxidant exhaust is fluidly coupled to the at least one wet chambers. A restriction means to variably restrict the net flow cross section of the plurality of dry chambers.

In another embodiment, a method for humidifying a fuel cell reactant for a fuel cell system is disclosed. The method includes providing a fuel cell system. The fuel cell system includes a fuel cell having a fuel cell reactant inlet; and a fuel cell oxidant exhaust; and a membrane exchange humidifier. The membrane exchange humidifier includes a dry stream inlet; a plurality of dry chambers defining a net flow cross section; at least one wet chamber; and a water permeable sheet membrane, wherein each of the plurality of dry chambers is separated from one or more of the at least one wet chambers by the water permeable sheet membrane whereby water is capable of being transferred across the water permeable sheet membrane; and a variable flow cross section restriction device fluidly connected to at least one of the plurality of dry chambers. The method includes directing, upstream of the fuel cell reactant inlet, a fuel cell reactant through the dry chamber. The method also includes directing, downstream of the fuel cell oxidant exhaust, an oxidant through the wet chamber; whereby water is transferred across the water permeable sheet membrane from the oxidant to the reactant. The method further includes variably restricting the net flow cross section of the plurality of dry chambers in response to an operational parameter of the fuel cell system.

### BRIEF DESCRIPTION OF THE SEVERAL VIEWS OF THE DRAWINGS

In the figures, identical reference numbers identify similar elements or acts. The sizes and relative positions of elements in the figures are not necessarily drawn to scale and some of these elements are arbitrarily enlarged and positioned to improve figure legibility. Further, the particular shapes of the elements as drawn are not intended to convey any information regarding the actual shape of the particular elements, and have been solely selected for ease of recognition in the figures.

FIG. 1 is an exploded view of a membrane exchange humidifier of the plate and frame variety according to a conventional design.

FIG. 2 is perspective view of a membrane exchange humidifier of the pleated variety, according to a conventional design.

FIG. 3A is a partially exploded perspective diagram illustrating a membrane exchange humidifier according to one illustrated embodiment.

FIG. 3B is a partially exploded perspective diagram illustrating a membrane exchange humidifier according to one illustrated embodiment.

FIG. 3C is a partially exploded perspective view illustrating a membrane exchange humidifier according to one illustrated embodiment.

FIG. 4A is an isometric view of a membrane exchange humidifier according to one illustrated embodiment.

FIG. 4B is an isometric view of a membrane exchange humidifier according to one illustrated embodiment.

FIG. 4C is an isometric view of a membrane exchange humidifier according to one illustrated embodiment.

FIG. 5 is a schematic diagram illustrating a fuel cell system according to one illustrated embodiment.

### DETAILED DESCRIPTION OF THE INVENTION

In the following description, certain specific details are set forth in order to provide a thorough understanding of various embodiments. However, one skilled in the art will understand that the invention may be practiced without these details. In other instances, well-known structures have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

The headings provided herein are for convenience only and do not interpret the scope or meaning of the claimed invention.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used herein, the terms “dry” and “wet” are relative terms as used and known in the art; “dry” does not necessarily mean the complete absence of water, and “wet” does not necessarily mean saturation with water. Likewise, the terms “high flow restriction” and “low flow restriction” are relative terms as used and known in the art, as are the terms “high pressure drop” and “low pressure drop”.

It has been found that when a fuel cell system is operating at a low electrical output mode, the combined parameters of humidity exchange pressure drop, associated water clearing ability, flow distribution and parasitic load of the oxidant compressor make a high-flow restriction membrane exchange humidifier desirable. It has also been found that when a fuel cell system is operating in a high electrical output mode, the combined parameters of humidity exchange, pressure drop, and associated water clearing ability and parasitic load of the oxidant compressor make a low-flow restriction membrane exchange humidifier desirable.

It has been further found that humidity exchange efficacy can be increased in a multi-chambered membrane exchange humidifier at low flows by ensuring that the dry stream and wet stream flows are optimized as between the multiple possible chambers. In particular, it has been found that humidity exchange efficacy can be increased in a multi-chambered membrane exchange humidifier at low flows by restricting the net flow cross section of the dry chambers or both the dry chambers and wet chambers to ensure that the dry stream and/or wet stream are at least partially confined to a reduced number of dry and wet chambers which are adjacent to one another. This ensures proximity of the wet and dry streams for humidity exchange across a water permeable membrane.

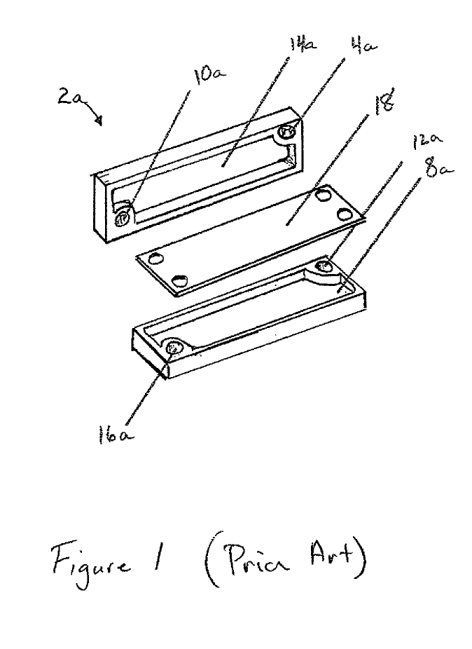

FIG. 1 shows a conventional membrane exchange humidifier 2a of the plate and frame variety. FIG. 1 shows a dry stream inlet 4a, a dry chamber 8a, and a dry stream exhaust 10a. FIG. 1 shows a wet stream inlet 12a, a wet chamber 14a and a wet stream exhaust 16a. FIG. 1 also shows a water permeable sheet membrane 18 separating the dry chamber 8a from the wet chamber 14a.

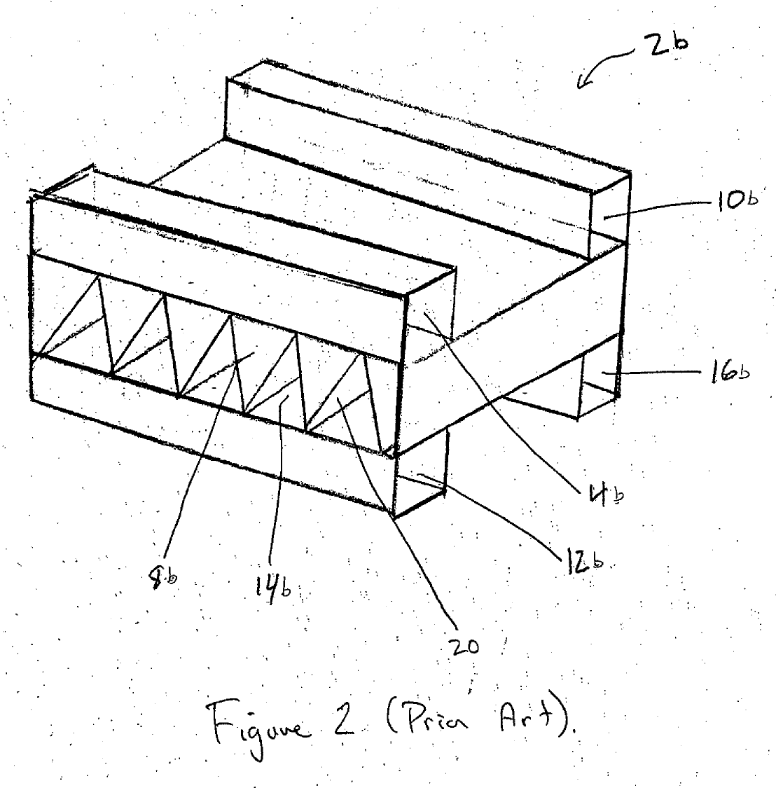

FIG. 2 shows a conventional membrane exchange humidifier 2b of the pleated variety. FIG. 2 shows a dry stream inlet 4b, a dry chambers 8b and a dry stream exhaust 10b. FIG. 2 shows a wet stream inlet 12b, wet chambers 14b and a wet stream exhaust 16b. FIG. 1 also shows a pleated water permeable sheet membrane 20 separating the dry chambers 8b from the wet chambers 14b.

The membrane exchange humidifiers 2a, 2b shown in FIGS. 1 and 2 have a fixed flow restriction defined principally by the membrane exchange humidifier's physical shape, size, geometric make-up and other parameters known to a person of ordinary skill in the art.

In operation, a dry stream is directed through the dry stream inlet 4a, 4b into the dry chamber 8a, 8b and is then exhausted out the dry stream exhaust 10a, 10b. The wet stream is directed through the wet stream inlet 12a, 12b, around the inside of the wet chamber 14a, 14b and is then exhausted out the wet stream exhaust 16a, 16b. While the dry and wet streams are in the dry chamber and wet chamber respectfully, water, or water vapor, from the wet stream may transfer through the water permeable sheet membrane 18, 20 humidifying the dry stream.

In one embodiment, the present membrane exchange humidifier comprises at least one wet chamber; a plurality of dry chambers; a water permeable sheet membrane; wherein each of the plurality of dry chambers is separated from one or more of the at least one wet chambers by the water permeable sheet membrane, whereby water is capable of being transferred across the water permeable sheet membrane; and a variable flow cross section restriction device fluidly connected to at least one of the plurality of dry chambers.

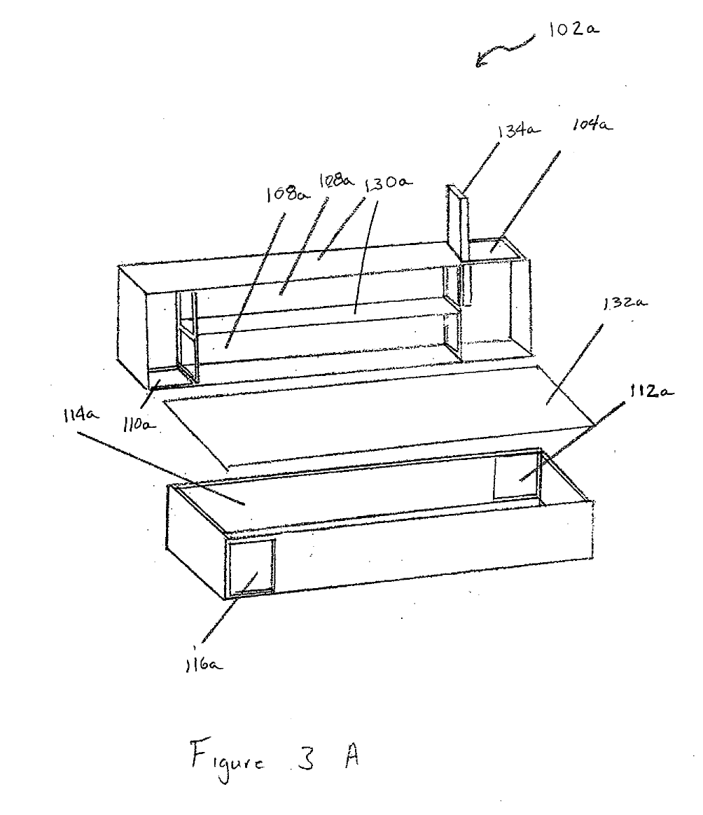

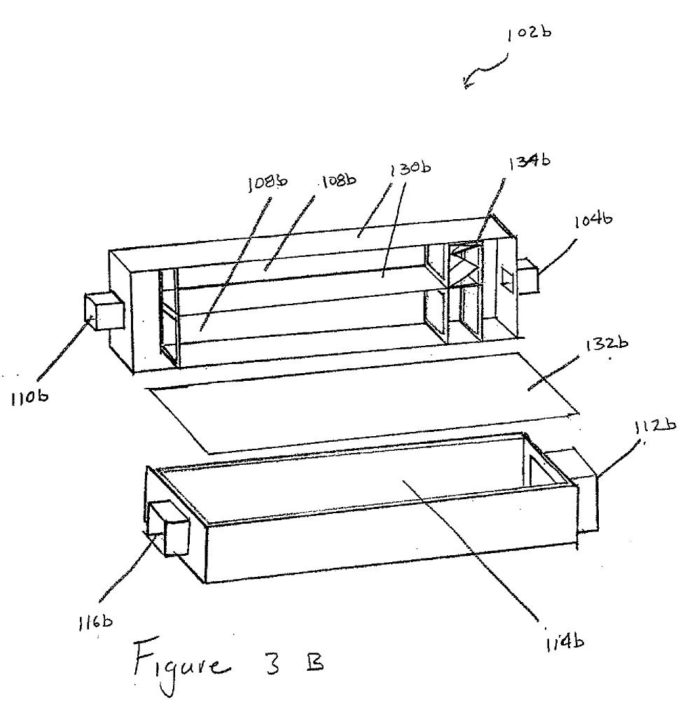

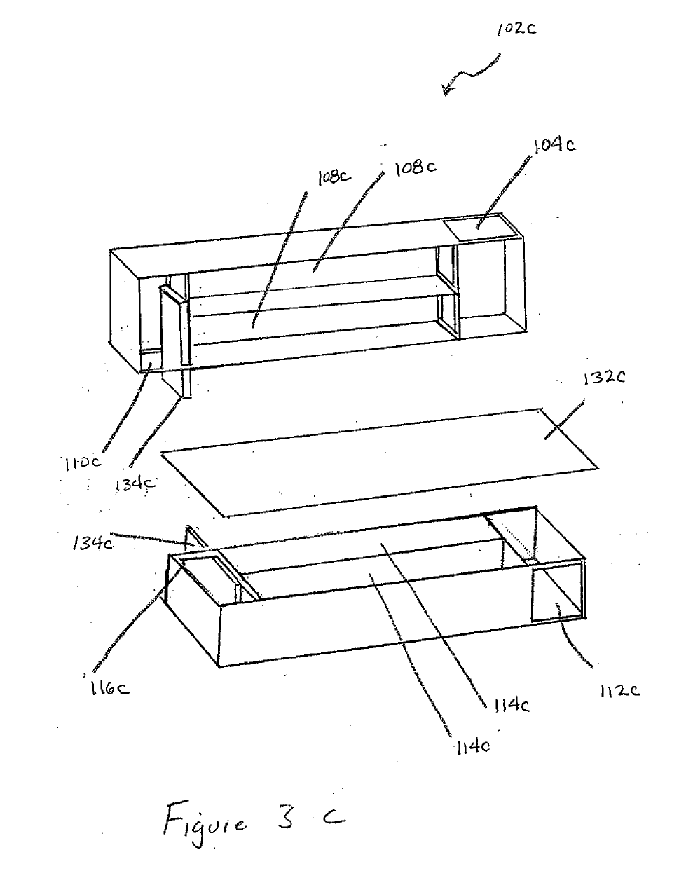

FIG. 3A shows one embodiment of the present membrane exchange humidifier 102a. FIG. 3A shows a dry stream inlet 104a, plates 130a, a water permeable sheet membrane 132a, two dry chambers 108a, and a dry stream exhaust 110a. FIG. 3A also shows a wet stream inlet 112a, a wet chamber 114a and a wet stream exhaust 116a. The dry chambers 108a and wet chamber 114a are defined by the cooperating surfaces of the water permeable sheet membrane 132a and opposing plates 130a respectfully. FIG. 3A further shows a sliding mask 134a located on the upstream side of the dry chambers 108a, operable to variably restrict the net flow cross section of the dry chamber 108a. For example, when the sliding mask 134a is in a partially closed state, the membrane exchange humidifier 102a will have a higher net flow restriction then when the sliding mask 134a is in a fully open state.

FIG. 3B shows one embodiment of the present membrane exchange humidifier 102b. FIG. 3B shows a dry stream inlet 104b, plates 130b, a water permeable sheet membrane 132b, two dry chambers 108b, and a dry stream exhaust 110b. FIG. 3B also shows a wet stream inlet 112b, wet chamber 114b and a wet stream exhaust 16. FIG. 3B further shows a baffle 134b located on the downstream side of the dry chambers 108b, operable to variably restrict the net flow cross section of the dry chambers 108b.

FIG. 3C is a cross sectional perspective view of one embodiment of the present membrane exchange humidifier 102c. FIG. 3C shows a dry stream inlet 104c, plates 130c, a water permeable sheet membrane 132c, two dry chambers 108c, and a dry stream exhaust 110c. FIG. 3C also shows a wet stream inlet 112c, two wet chambers 114c and a wet stream exhaust 116c. FIG. 3C further shows sliding masks 134c located on the downstream side of the dry chambers 108c and wet chambers 114c operable to variably restrict the respective net flow cross sections of the dry chambers 108c and/or wet chambers 114c.

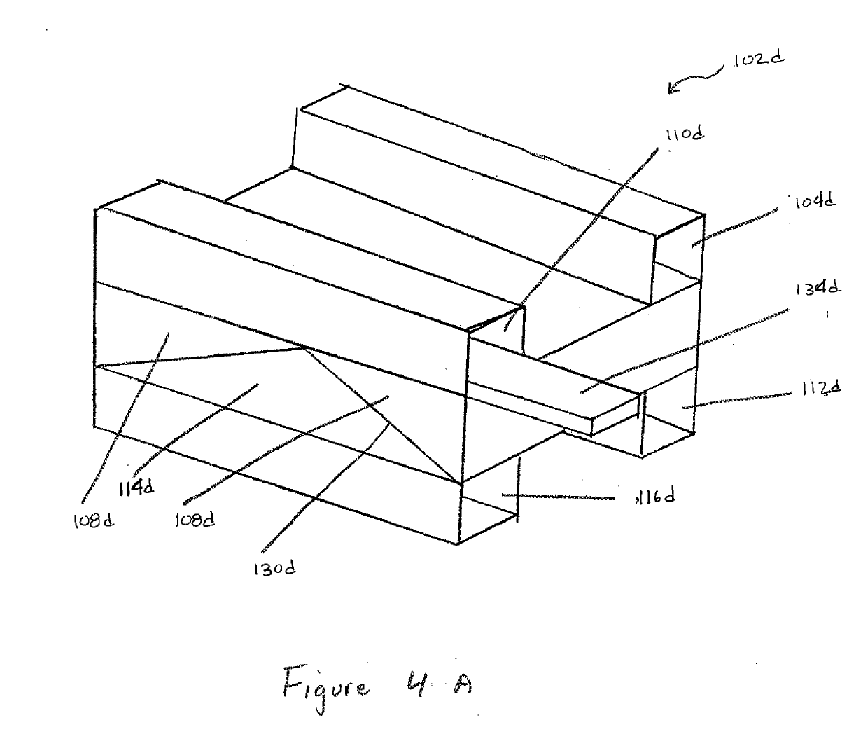

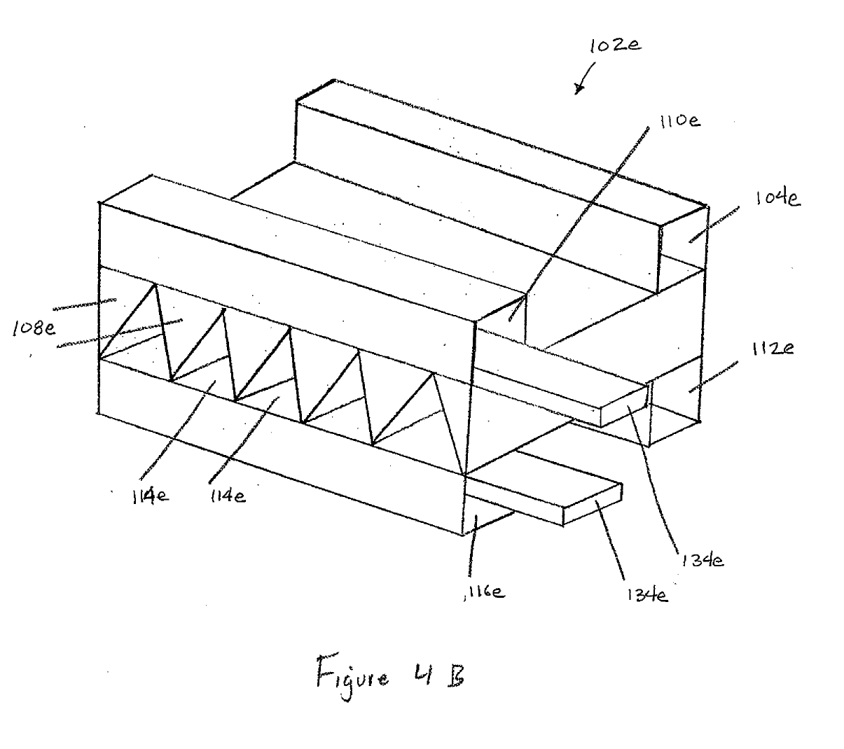

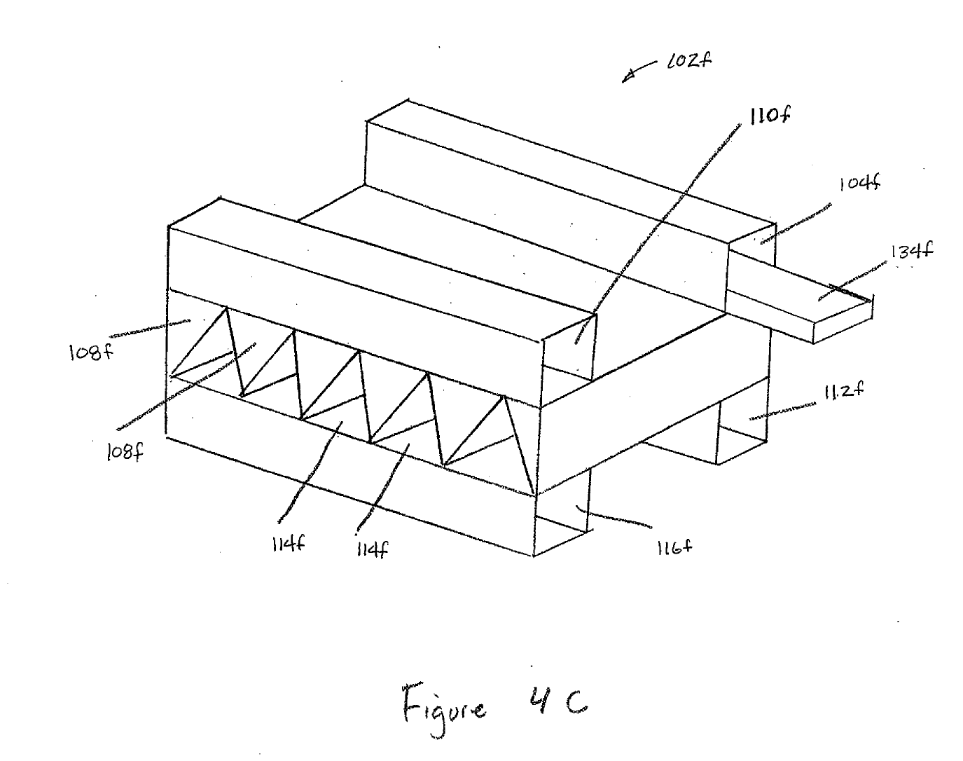

FIG. 4A shows another embodiment of the present membrane exchange humidifier 102d. FIG. 4A shows a dry stream inlet 104d, a pleated water permeable sheet membrane 130d, dry chambers 108d and a dry stream exhaust 110d. FIG. 4A also shows a wet stream inlet 112d, a wet chamber 114d, and a wet stream exhaust 116d. FIG. 4A further shows a sliding mask 134d located on the downstream side of the dry chambers 108d to variably restrict the net flow cross section of the dry chambers 108d.

FIG. 4B shows another embodiment of the present membrane exchange humidifier 102a. FIG. 4B shows a dry stream inlet 104e, a pleated water permeable sheet membrane 130e, dry chambers 108e and a dry stream exhaust 110e. FIG. 3C also shows a wet stream inlet 112e, wet chambers 114e, and a wet stream exhaust 116e. FIG. 3C further shows two sliding masks 134e located on the downstream side of the dry chambers 108e and wet chamber 114e respectfully, and operable to variably restrict the respective net flow cross sections of the dry chambers 108e and wet chambers 114e.

FIG. 4C shows another embodiment of the present membrane exchange humidifier 102f. FIG. 4C shows a dry stream inlet 104f, a pleated water permeable sheet membrane 130f, dry chambers 108f and a dry stream exhaust 110f. FIG. 4C also shows a wet stream inlet 112f, wet chambers 114f, and a wet stream exhaust 116f. FIG. 4C further shows a sliding mask 136f located on the downstream side of the dry chambers 108f operable to respectfully variably restrict the net flow cross section of dry chambers 108f.

The number of wet chambers 114a-114f is not essential to the present membrane exchange humidifier 102a-102f. Likewise, the number of dry chambers 108a-108f is not essential to the present membrane exchange humidifier 102a-102f provided the number of dry chambers 108a-108f is greater then one. A person of ordinary skill in the art may select the number of dry chambers 108a-108f and wet chambers 114a-114f to suit the requirements for a particular application.

The dry chambers 108a-108f need not be completely fluidly isolated from one another provided the net flow cross section of the dry chambers 108a-108f may be variably restricted, as desired. Likewise, where more then one wet chamber 114a-114f is employed, the wet chambers 114a-114f need not be completely fluidly isolated from one another provided the net flow cross section of the wet chambers 114a-114f may be variably restricted, as desired.

Where more then one wet chamber 114a-114f is employed, the present membrane exchange humidifier 102a-102f may preferably employ a variable flow cross section restriction device 134a-134f to restrict the net flow cross section of the wet chambers 114a-114f, in addition to the variable flow cross section restriction device 134a-134f employed to restrict the net flow cross section of the dry chambers 108a-108f. A single variable flow cross section restriction device 134a-134f may reduce the net flow cross section of the dry chambers 108a-108f alone or both the dry chambers 108a-108f and wet chambers 114a-114f, where more then one wet chamber 114a-114f is employed. The variable flow cross section restriction device 134a-134f may be located on the upstream side of the chambers 108a-108f, 114a-114f or may be advantageously located on the downstream side of the chambers 108a-108f, 114a-114f to minimize the effect of pressurizing newly opened volume on up-transients.

A person of ordinary skill in the art may select the variable flow cross section restriction device or variable flow cross section restriction device in the embodiments depicted in FIGS. 3A to 4C to be a sliding mask, louver, plug, rotating mask, moving plunger, valve, baffle, switch, solenoid, actuator or other restricting or blocking means known in the art, or combinations thereof, for a desired application. Variable flow cross section restriction device 134a-134f may be operated in any state between and including fully opened and fully closed as required to maintain the desired level of flow restriction and humidification. The embodiments of the present membrane exchange humidifier 102a-102f shown in FIGS. 3A to 4C may therefore be variably configured to have from a high flow restriction to a low flow restriction.

The form of the water permeable sheet membrane 132a-132f is not essential to various embodiments of the present membrane exchange humidifier 102a-102f. For example, a person of ordinary skill in the art may select the water permeable sheet membrane 132a-132f to be substantially planer, creased pleated, or have a rolling wave conformation, defining chambers of a regular or irregular shape of consistent or inconsistent size as desired for a particular application.

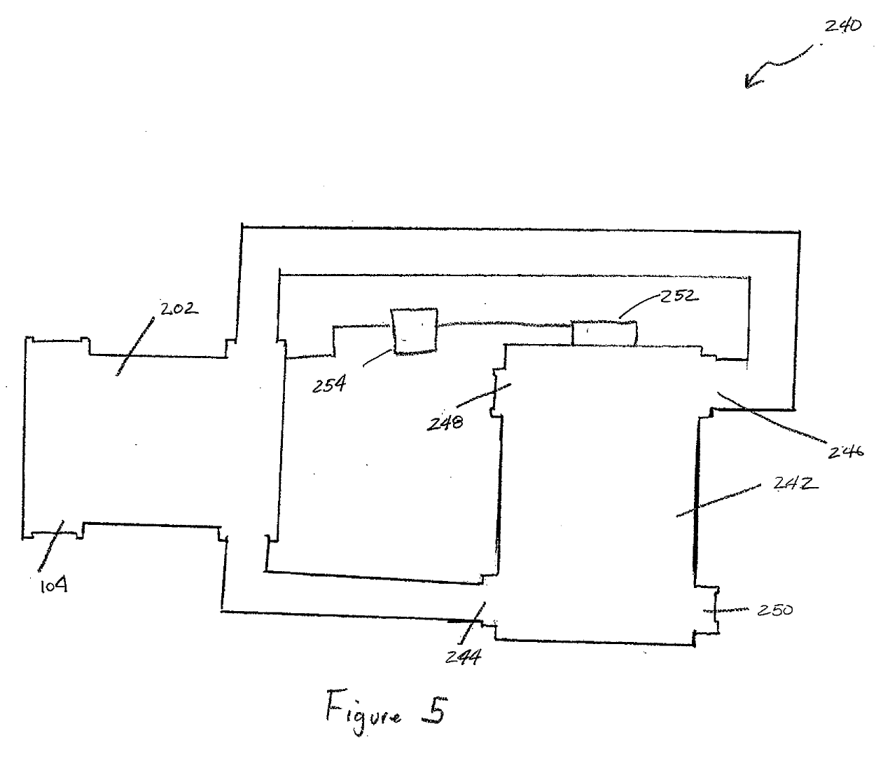

FIG. 5 shows an embodiment of the present fuel cell system 240 showing a fuel cell 242 and a membrane exchange humidifier 202. The fuel cell 242 includes a fuel cell reactant inlet 244 and a fuel cell oxidant exhaust 246. The membrane exchange humidifier 202 may be of a form as described above with respect to FIGS. 3A to 4C. For example, a dry chamber 108a-108f may be fluidly coupled between the dry stream inlet 104a-104f (collectively 104) and the fuel cell reactant inlet 244. The fuel cell oxidant exhaust 246 may be fluidly coupled to the wet chamber 114a-114f. The membrane exchange humidifier 202 further includes a variable flow cross section restriction device 134a-134f. The variable flow cross section restriction device 134a-134f may be of a form as discussed above with respect to FIGS. 3A to 4C. Indeed, any embodiments of the membrane exchange humidifier 102a-102f described above with respect of FIGS. 3A to 4C may be employed for the membrane exchange humidifier 202 of the fuel cell system 240.

In operation, wet oxidant (as water is constituent in the oxidant exhaust as a result of the fuel cell reaction (2) set out above) is expelled from the fuel cell oxidant exhaust 246 to the wet chamber 114a-114f. Dry fuel cell reactant flows into the dry chamber 108a-108f via the dry stream inlet 104. Water or water vapor may be transferred across the water permeable sheet membrane 132a-132f from the wet oxidant to the dry fuel cell reactant. The variable flow cross section restriction device 134a-134f may be operated to variably restrict the flow cross section of the dry chamber 108a-108f in response to an operation parameter of the fuel cell system. For example, where there is an increase in system load or current, the variable flow cross section restriction device 134a-134f may operate to reduce the net flow restriction of the membrane exchange humidifier 202.

The operational parameter is not essential to the present fuel cell system 240. A person of ordinary skill in the art may select an operational parameters of the fuel cell system 240 from the voltage across a fuel cell stack, voltage across a single fuel cell, voltage across a group of fuel cells; current through the fuel cell stack, system load, oxidant flow rate, fuel flow rate, or other operational parameters known in the art, or combinations thereof, as desired for a particular application.

The fuel cell 242 may also further include a second reactant inlet and exhaust 248, 250 and further fuel cells electrically coupled in series to form a fuel cell stack, if desired, and may include fuel cells or fuel cell stacks electrically coupled in parallel, for example, if desired.

Some embodiments of the fuel cell system 240 may optionally include a sensor 252 and controller 254. The controller 254 may be communicatively coupled to one or more sensors 252 which detect operational parameters of the fuel cell system 240. The sensors 252 communicate signals to the controller 254 corresponding to the sensed operational parameter. Based upon the sensed operational parameter, controller 254 may control operation of the variable flow cross section device 134a-134f in accordance with the operating strategies described above.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other humidifiers or fuel cell systems not necessarily the exemplary humidifiers or fuel cell systems generally described above.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A fuel cell membrane exchange humidifier, comprising:
at least one wet chamber;
a plurality of dry chambers;
a water permeable sheet membrane;
wherein each of the plurality of dry chambers is separated from one or more of the at least one wet chambers by the water permeable sheet membrane,
whereby water is capable of being transferred across the water permeable sheet membrane; and
at least a first variable flow cross section restriction device fluidly connected to at least one of the plurality of dry chambers.

2. The membrane exchange humidifier of claim 1, further comprising at least a second variable flow cross section restriction device fluidly connected to the at least one wet chamber.

3. The membrane exchange humidifier of claim 1, further comprising a controller.

4. The membrane exchange humidifier of claim 1 wherein the first variable flow cross section restriction device is selected from the group consisting of sliding mask, rotating mask, moving plunger, valve, baffle, louver, plug, switch, solenoid and actuator.

5. The membrane exchange humidifier of claim 1 wherein the first variable flow cross section restriction device is a sliding mask.

6. The membrane exchange humidifier of claim 1 wherein the first variable flow cross section restriction device is a baffle.

7. A fuel cell system, comprising:
a fuel cell comprising a fuel cell reactant inlet; and a fuel cell oxidant exhaust;
a membrane exchange humidifier comprising a dry stream inlet; a plurality of dry chambers; at least one wet chamber; and a water permeable sheet membrane, wherein each of the plurality of dry chambers is separated from one or more of the at least one wet chambers by the water permeable sheet membrane whereby water is capable of being transferred across the water permeable sheet membrane;
wherein the dry chambers are fluidly coupled between the dry stream inlet and the fuel cell reactant inlet; wherein the fuel cell oxidant exhaust is fluidly coupled to the at least one wet chambers; and
at least a first variable flow cross section restriction device fluidly connected to at least one of the plurality of dry chambers.

8. The fuel cell system of claim 7, further comprising at least a second variable flow cross section restriction device fluidly connected to the at least one wet chamber.

9. The fuel cell system of claim 7 wherein the first variable flow cross section restriction device is selected from the group of consisting sliding mask, rotating mask, moving plunger, valve, baffle, louver, plug, switch, solenoid and actuator.

10. The fuel cell system of claim 7 wherein the first variable flow cross section restriction device is a sliding mask.

11. The fuel cell system of claim 7 wherein the first variable flow cross section restriction device is a baffle.

12. The fuel cell system of claim 7, further comprising a controller coupled to operate the first variable flow cross section restriction device.

13. A fuel cell membrane exchange humidifier, comprising:
at least one wet chamber;
a plurality of dry chambers defining a net flow cross section;
a water permeable sheet membrane;
wherein each of the plurality of dry chambers is separated from one or more of the at least one wet chambers by the water permeable sheet membrane, whereby water is capable of being transferred across the water permeable sheet membrane; and
a restriction means to variably restrict the net flow cross section of the plurality of dry chambers.

14. The membrane exchange humidifier of claim 13, further comprising a controller.

15. The membrane exchange humidifier of claim 13 wherein the restriction means is selected from the group consisting of sliding mask, rotating mask, moving plunger, valve, baffle, louver, plug, switch, solenoid and actuator.

16. The membrane exchange humidifier of claim 13 wherein the restriction means is a sliding mask.

17. The membrane exchange humidifier of claim 13 wherein the restriction means is a baffle.

18. A fuel cell system, comprising:
a fuel cell comprising a fuel cell reactant inlet; and a fuel cell oxidant exhaust;
a membrane exchange humidifier comprising a dry stream inlet; a plurality of dry chambers defining a net flow cross section; at least one wet chamber; and a water permeable sheet membrane, wherein each of the plurality of dry chambers is separated from one or more of the at least one wet chambers by the water permeable sheet membrane whereby water is capable of being transferred across the water permeable sheet membrane;
wherein the dry chambers are fluidly coupled between the dry stream inlet and the fuel cell reactant inlet; wherein the fuel cell oxidant exhaust is fluidly coupled to the at least one wet chambers; and
a restriction means to variably restrict the net flow cross section of the plurality of dry chambers.

19. The fuel cell system of claim 16 wherein the restriction means is selected from the group of consisting sliding mask, rotating mask, moving plunger, valve, baffle, louver, plug, switch, solenoid and actuator.

20. The fuel cell system of claim 18 wherein the restriction means is a sliding mask.

21. The fuel cell system of claim 18 wherein the restriction means is a baffle.

22. The fuel cell system of claim 18, further comprising a controller coupled to control the restriction means to variably restrict the net flow cross section of the plurality of dry chambers.

23. A method for humidifying a fuel cell reactant for a fuel cell system, comprising:
providing a fuel cell system comprising:
a fuel cell having a fuel cell reactant inlet; and a fuel cell oxidant exhaust;
a membrane exchange humidifier comprising a dry stream inlet; a plurality of dry chambers defining a net flow cross section; at least one wet chamber; and a water permeable sheet membrane, wherein each of the plurality of dry chambers is separated from one or more of the at least one wet chambers by the water permeable sheet membrane whereby water is capable of being transferred across the water permeable sheet membrane;
a variable flow cross section restriction device fluidly connected to at least one of the plurality of dry chambers;
directing, upstream of the fuel cell reactant inlet, a fuel cell reactant through the dry chamber; directing, downstream of the fuel cell oxidant exhaust, an oxidant through the wet chamber; whereby water is transferred across the water permeable sheet membrane from the oxidant to the reactant; and
variably restricting the net flow cross section of the plurality of dry chambers in response to an operational parameter of the fuel cell system.

24. The method of claim 23 wherein the variable flow cross section restriction device is selected from the group consisting of a sliding mask, a rotating mask, a moving plunger, a valve, a baffle, a louver, a plug, a switch, a solenoid and an actuator.

25. The method of claim 23 wherein the variable flow cross section restriction device is a sliding mask and variably restricting the net flow cross section of the plurality of dry chambers in response to an operational parameter of the fuel cell system includes moving the sliding mask.

26. The method claim 23 wherein the variable flow cross section restriction device is a baffle and variably restricting the net flow cross section of the plurality of dry chambers in response to an operational parameter of the fuel cell system includes adjusting the baffle.

27. The method of claim 23 wherein the operational parameter is selected from the group consisting of a fuel cell voltage, a stack voltage, a cell current, a load and a reactant flow rate and variably restricting the net flow cross section of the plurality of dry chambers in response to an operational parameter of the fuel cell system includes adjusting a position of the variable flow cross section restriction device based at least in part on at least one of the fuel cell voltage, the stack voltage, the cell current, the load or the reactant flow rate.
